(19) United States
(12) Patent Application Publication
(10) Pub. No.: US 2026/0074277 A1
(43) Pub. Date: Mar. 12, 2026

(54) BATTERY ELECTROLYTE

(71) Applicant: FORD GLOBAL TECHNOLOGIES, LLC, Dearborn, MI (US)

(72) Inventors: Zijie LU, Novi, MI (US); Andrew Robert DREWS, Ann Arbor, MI (US)

(21) Appl. No.: 18/830,105

(22) Filed: Sep. 10, 2024

(51) Int. Cl. H01M 10/0562; H01M 4/02; H01M 4/36; H01M 4/38; H01M 4/505; H01M 4/525; H01M 4/62; H01M 10/052; H01M 50/431; H01M 50/474

(52) U.S. Cl. CPC H01M 10/0562; H01M 4/362; H01M 4/386; H01M 4/505; H01M 4/525; H01M 4/622; H01M 10/052; H01M 50/431; H01M 50/474; H01M 2004/027; H01M 2004/028

(57) ABSTRACT

The present disclosure relates to a solid-state battery cell and methods for its manufacture. The battery cell includes a silicon-based anode with a sulfide anolyte, a nickel cobalt manganese cathode with an oxychloride catholyte, and a bi-layer solid electrolyte separator that is positioned between and in direct contact with the anode and the cathode. The separator includes a first layer of sulfide-type solid electrolyte adjacent to the anode and a second layer of oxychloride-type solid electrolyte adjacent to the cathode.

### TECHNICAL FIELD

This disclosure relates to electrolytes for lithium-ion batteries.

### BACKGROUND

Solid-state batteries have high energy density but require high-performance solid electrolytes, cathodes, and anodes. However, their poor electrochemical stability above 3.0 volts (V) compared to lithium-ion/lithium limits their use with high-voltage cathodes.

### SUMMARY

A solid-state battery cell includes a silicon-based anode with a sulfide anolyte, a nickel cobalt manganese cathode with an oxychloride catholyte, and a bi-layer solid electrolyte separator between and in direct contact with the anode and the cathode, with a first layer of sulfide-type solid electrolyte adjacent to the anode and a second layer of oxychloride-type solid electrolyte adjacent to the cathode. The sulfide-type solid electrolyte in the anode and the first layer of the separator may be an argyrodite having a formula Li₆PS₅X, where X is Cl or Br. The oxychloride-type solid electrolyte in the cathode and the second layer of the separator may be Li_{2.5-y}ZrCl_{5.5-y}O_{0.5} where 0<y≤1.0. Silicon particles in the silicon-based anode may be selected from a group consisting of silicon nanoparticles, silicon microparticles, SiOₓ nanoparticles where 0<x<2, SiOₓ microparticles where 0<x<2, and silicon-carbon composites. The nickel cobalt manganese in the cathode may be LiNiₓCo_{y}Mn_{1-x-y}O₂, where x>0.7. The nickel cobalt manganese may be NCM811. At least one of the anode and the cathode may further include a carbon additive. At least one of the anode and the cathode may further include a polymeric binder. At least one layer of the bi-layer solid electrolyte separator may further include a polymeric binder.

A method of manufacturing a solid-state battery cell includes forming an anode by combining a silicon-active material with a sulfide-type solid electrolyte, forming a cathode by combining a high-nickel nickel cobalt manganese with an oxychloride-type solid electrolyte, forming a bi-layer solid electrolyte separator by depositing a first layer of sulfide-type solid electrolyte and depositing a second layer of oxychloride-type solid electrolyte on the first layer, and assembling the anode, cathode, and bi-layer solid electrolyte separator such that the first layer of the separator is adjacent to the anode and the second layer of the separator is adjacent to the cathode. The sulfide-type solid electrolyte may be an argyrodite having a formula Li₆PS₅X, where X is Cl or Br. The oxychloride-type solid electrolyte may be Li_{2.5-y}ZrCl_{5.5-y}O_{0.5} where 0<y≤1.0. In some configurations, the method further comprises adding a carbon additive to at least one of the anode and the cathode. In other configurations, the method further comprises adding a polymeric binder to at least one of the anode, the cathode, and the bi-layer solid electrolyte separator.

A solid-state battery system includes an anode composite of silicon active material and an argyrodite-type solid electrolyte, a cathode composite of nickel cobalt manganese and a spinel-structured oxide solid electrolyte, and a dual electrolyte solid separator between and in direct contact with the anode and the cathode, the separator having a first layer of argyrodite-type solid electrolyte adjacent to the anode and a second layer of spinel-structured oxide solid electrolyte adjacent to the cathode. The argyrodite-type solid electrolyte in the anode and the first layer of the separator may be Li₆PS₅X, where X is Cl or Br, and the spinel-structured oxide solid electrolyte in the cathode and the second layer of the separator is Li _{2.5-y}ZrCl_{5.5-y}O_{0.5} where 0<y≤1.0. The silicon active material in the anode may be selected from a group consisting of silicon nanoparticles, silicon microparticles, SiOₓ nanoparticles where 0<x<2, SiOₓ microparticles where 0<x<2, and silicon-carbon composites, and the nickel cobalt manganese in the cathode has the formula LiNiₓCo_{y}Mn_{1-x-y}O₂, where x>0.7. The nickel cobalt manganese may be NCM811. At least one of the anode and the cathode may include a carbon additive. At least one layer of the dual electrolyte solid separator may include a polymeric binder.

### BRIEF DESCRIPTION OF THE DRAWINGS

FIG. 1 is a schematic diagram of a solid-state battery;

FIG. 2 is a graph of electrolyte current density compared to potential;

FIG. 3 is a graph of electrolyte voltage compared to potential;

FIG. 4 is a graph of electrolyte capacity compared to cycle number; and

FIG. 5 is a flowchart of a method of forming the solid-state battery of FIG. 1.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein, such as the composition of the silicon-based anode with sulfide anolyte, the nickel cobalt manganese cathode with oxychloride catholyte, and the bi-layer solid electrolyte separator, are not to be interpreted as limiting, but merely as a representative basis for teaching one skilled in the art to variously employ embodiments of the claimed subject matter in solid-state battery technology.

Unless otherwise explicitly specified, all numerical values and ranges relating to quantities, measurements, percentages, weights, and similar numerical references within this document are to be understood as being preceded by the term “about. ” This applies even in cases where the term “about” is not explicitly used. It is intended that all values and ranges encompass variations that may arise from standard measurement, manufacturing processes, material properties, and intended functionality of aspects of the disclosure. For example, when the oxychloride-type solid electrolyte is described as having the formula “Li_{2.5-y}ZrCl_{5.5-y}O_{0.5},” it is to be understood as “about Li_{2.5-y}ZrCl_{5.5-y}O_{0.5}.” Furthermore, when numerical values are presented as a range, such as “x>0.7” in the formula LiNiₓCo_{y}Mn_{1-x-y}O₂ for the nickel cobalt manganese cathode, this range should be interpreted to effectively mean “about x>0.7.” Similarly, when silicon oxide particles are described as “SiOₓ where 0<x<2,” it should be understood as “SiOₓ where about 0<x<about 2.” Such variations are implicitly incorporated within the scope of the present disclosure, including all compositions, structures, and methods described in the following claims.

A silicon anode combined with a high-nickel layered cathode offers an attractive chemistry for high-energy solid-state batteries. However, current electrolytes may react adversely with high-nickel cathodes due to low oxidation stability.

The present disclosure relates to solid-state battery configurations and methods for its manufacture. The presented solid-state battery utilizes a dual solid electrolyte system, combining the advantages of a lithium phosphorus sulfur chloride (LPSC) electrolyte and a lithium zirconium chloride oxide (LZCO) electrolyte to form a high-performance energy storage solution. This arrangement includes strategic use of the two distinct solid electrolytes with LZCO acting as the catholyte, and LPSC functioning as the anolyte. This dual-electrolyte approach is implemented through a bi-layer solid electrolyte separator, specifically configured to complement the respective catholyte and anolyte materials. The LZCO catholyte is a specifically synthesized oxychloride solid electrolyte, which exhibits stability at high oxidative voltages up to 4.2 V. This characteristic makes it particularly suitable for use with high-voltage cathode materials, addressing the limitations of many existing solid electrolytes.

On the anode side, the LPSC electrolyte is utilized due to its high stability against reductive voltages, making it an ideal choice for pairing with a silicon anode. This combination allows for the exploitation of silicon's high theoretical capacity while mitigating stability issues often encountered in solid-state battery designs.

The composite anode in this battery system includes two main components a silicon-based (Si-based) active material and the LPSC anolyte. The Si active material may take various forms, including pure Si nano- and micro-particles, Si oxide (SiOₓ where 0<x<2) nano-and micro-particles, or Si-Carbon (Si—C) composites. To increase the electrode's performance, small amounts of C additives such as C black and polymeric binder may be incorporated to increase electrical conductivity and mechanical integrity, respectively.

The cathode structure proposed is a similar composite to that of the anode. The high-nickel cobalt manganese (NCM) such as NCM811 has the formula LiNiₓCo_{y}Mn_{1-x-y}O₂, where (x>0.7, such as NCM811) is the active material and the aforementioned LZCO is the catholyte. Similar to the anode, C additives such as C black, and polymeric binders may be included to increase conductivity and structural stability.

The bi-layer solid electrolyte separator includes an LPSC layer corresponding to the anolyte composition and an LZCO layer corresponding to the catholyte. The use of a small amount of polymeric binder in each layer increases the mechanical strength and integrity of the separator structure. Specifically, the LZCO electrolyte may have the chemical formula Li_{2.5-y}ZrCl_{5.5-y}O_{0.5} where 0<y≤1.0. The catholyte may have the composition Li_{1.75}ZrCl_{4.75}O_{0.5}. The LPSC electrolyte may be an argyrodite with the formula Li₆PS₅X where X is Cl or Br.

This dual solid electrolyte system enables the use of high-capacity Si anodes and high-voltage cathodes without requiring active material coatings. The stability of the LZCO catholyte at high oxidizing voltages increases both the electrochemical performance and long-term durability of the solid-state batteries in which it may be incorporated. The high ionic conductivities of both the LPSC and LZCO components facilitate efficient ionic transport throughout the solid-state battery structure.

Furthermore, the mechanical properties of the LPSC, particularly its low elastic modulus and malleability, may help maintain contact between the Si anode and the electrolyte during cycling, contributing to extended cycle life. The composite electrodes and bi-layer electrolyte separator may be manufactured using established large-scale production methods.

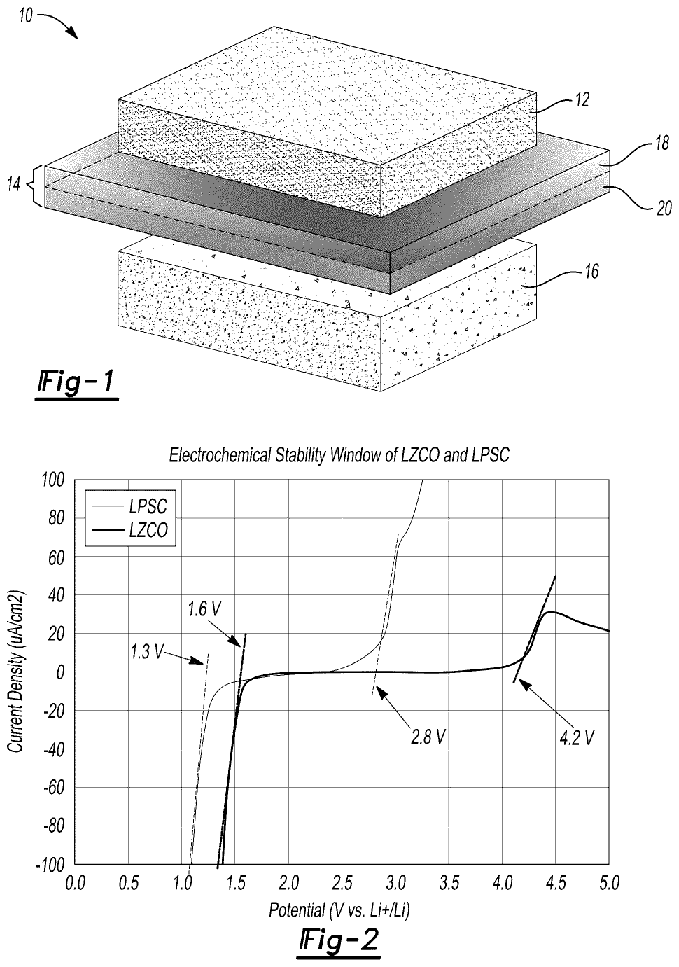

FIG. 1 is a schematic diagram of a solid-state battery cell 10. An anode 12, which may be a Si-based anode composite, incorporates Si particles. The Si particles may be in the form of nanoparticles, microparticles, SiOx particles (where 0<x<2), or Si—C composites. The anode also contains a sulfide anolyte, which may specifically be an argyrodite-type solid electrolyte with the formula Li₆PS₅X, where X is Cl or Br. Layered with the anode 12 is a bi-layer solid electrolyte separator 14. The bi-layer solid electrolyte separator 14 is in direct contact with both the anode 12 and a cathode 16. A top layer of the separator 18 includes a sulfide-type solid electrolyte, corresponding to the composition of the anolyte in the anode 12 having a formula Li₆PS₅X. The top layer of the separator 18 is adjacent to and in direct contact with the anode 12. The bottom layer of the separator 20 is an oxychloride-type solid electrolyte, specifically Li_{2.5-y}ZrCl_{5.5-y}O_{0.5}. The bottom layer of the separator 20 is positioned adjacent to and in direct contact with the cathode 16. The cathode 16 may be a composite of NCM active material and the oxychloride catholyte. The NCM may have the formula LiNiₓCo_{y}Mn_{1-x-y}O₂, where x>0.7, with NCM811 being a specific example used in the solid-state battery cell 10. Both the anode 12 and the cathode 16 may include additional components such as C additives to increase conductivity and polymeric binders to increase structural integrity. The C additives may be additives such as C black, graphene, C nanotubes, or acetylene black. The polymeric binders may be materials such as polyvinylidene fluoride, carboxymethyl cellulose, styrene-butadiene rubber, or polyethylene oxide. Similarly, the layers of the bi-layer solid electrolyte separator 14 may also incorporate polymeric binders for increased mechanical properties.

FIG. 2 is a graph of the electrochemical stability windows of LZCO and LPSC. The graph plots current density (μA/cm2) against potential (V vs. Li+/Li) for LZCO and LPSC. The potential range spans from 0 to 5.0 V, while the current density axis extends from −100 to 100 μA/cm2. The LPSC curve shows a sharp increase in cathodic current below 1.3 V, indicating its reduction potential, and remains relatively stable until 2.8 V, above which a significant increase in anodic current suggests oxidation. In contrast, the LZCO curve demonstrates a reduction potential at 1.6 V and maintains stability up to 4.2 V before showing signs of oxidation. These stability windows are clearly marked on the graph at 1.3 V to 2.8 V for LPSC and at 1.6 V to 4.2 V for LZCO. The figure highlights LZCO's superior oxidative stability, which makes it particularly suitable for high-voltage cathode materials, while LPSC's lower reduction potential suggests better compatibility with low-voltage anode materials.

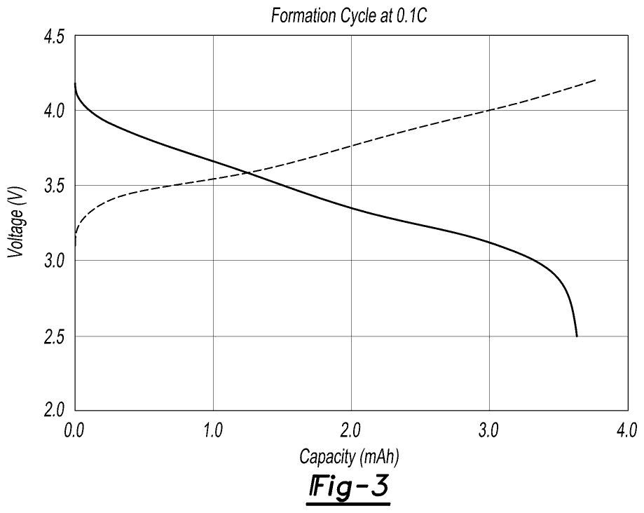

FIG. 3 shows the formation cycle characteristics of LPSC and LZCO, at a charging rate of 0.1 coulombs (C). The graph plots V against capacity (mAh) for LPSC and LZCO. The x-axis represents the capacity and ranges from 0 to 4.0 mAh, while the y-axis shows the V, spanning from 2.0 to 4.5 V. The LPSC curve shows an increasing V profile, starting at approximately 3.2 V and rising steadily to about 4.2 V as the capacity increases to 4.0 mAh. This upward trend suggests a consistent charging behavior for LPSC. In contrast, the LZCO curve exhibits a decreasing voltage profile, beginning at around 4.2 V and declining to about 2.5 V as the capacity reaches 3.7 mAh.

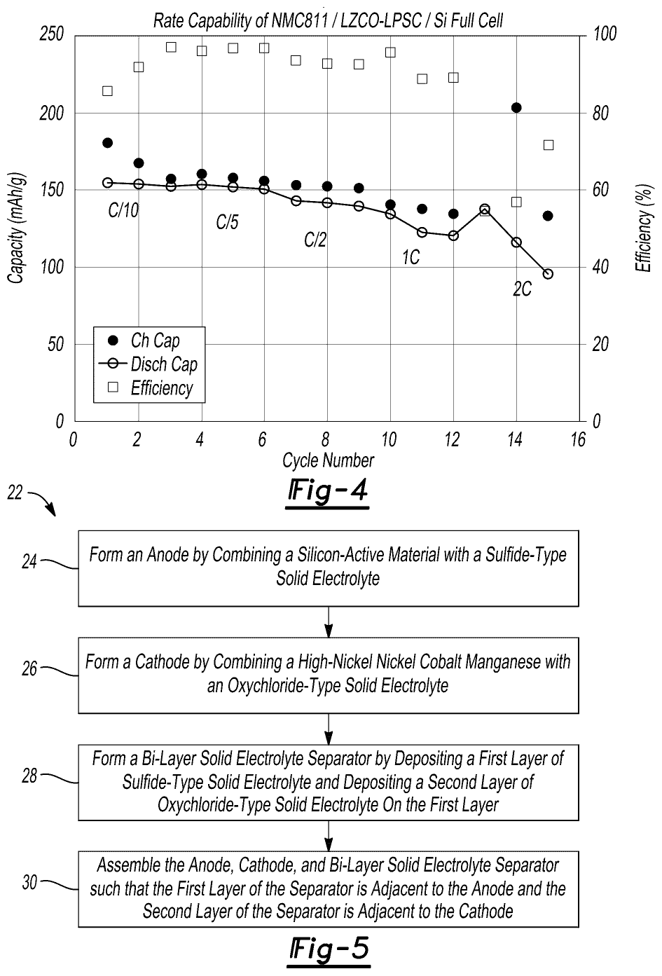

FIG. 4 shows the rate capability of a full cell solid-state battery composed of an NMC811 cathode, LZCO-LPSC dual electrolyte, and Si anode. The graph plots capacity in mAh/g and efficiency (%) against cycle number, for performance across various C-rates from C/10 to 2C. The parameters tracked are charge capacity, discharge capacity, and efficiency. The cell exhibits high initial capacity at C/10, with charge capacity reaching about 180 mAh/g and efficiency quickly rising to nearly 100%. As C-rates increase, a gradual decrease in capacity is observed, with discharge capacity dropping from around 160 mAh/g at C/5 to approximately 140 mAh/g at C/2, and further to about 120 mAh/g at 1C. Notably, the cell maintains high efficiency throughout these rates. At 2C, there is a more significant capacity drop to about 100 mAh/g, accompanied by a decrease in efficiency to around 70%. The data suggests that this NMC811/LZCO-LPSC/Si configuration exhibits high rate capability, particularly at moderate C-rates, indicating its potential for high-performance solid-state battery applications.

FIG. 5 is a flowchart of a method of manufacturing a solid-state battery cell 22. Step 24 includes combining a silicon-active material with a sulfide-type solid electrolyte. The sulfide-type solid electrolyte may be an argyrodite with the formula Li₆PS₅X, where X is either Cl or Br. Step 26 is the formation of the cathode, which combines an NCM material with an oxychloride-type solid electrolyte. The oxychloride-type solid electrolyte may have the composition Li_{2.5-y}ZrCl_{5.5-y}O_{0.5}. Step 28 is the formation of a bi-layer solid electrolyte separator, which is a two-part process of first, depositing a layer of sulfide-type solid electrolyte, and then depositing a second layer of oxychloride-type solid electrolyte on top of the first layer. Step 30 is the assembly of the solid-state battery cell 10, where the anode, cathode, and bi-layer solid electrolyte separator are assembled such that the sulfide-type first layer of the separator is adjacent to the anode, and the oxychloride-type second layer is adjacent to the cathode.

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. A solid-state battery cell comprising:
a silicon-based anode with a sulfide anolyte;
a nickel cobalt manganese cathode with an oxychloride catholyte; and
a bi-layer solid electrolyte separator between and in direct contact with the anode and the cathode, with a first layer of sulfide-type solid electrolyte adjacent to the anode and a second layer of oxychloride-type solid electrolyte adjacent to the cathode.

2. The solid-state battery cell of claim 1 wherein the sulfide-type solid electrolyte in the anode and the first layer of the bi-layer solid electrolyte separator is an argyrodite having a formula Li₆PS₅X, where X is Cl or Br.

3. The solid-state battery cell of claim 1 wherein the oxychloride-type solid electrolyte in the cathode and the second layer of the bi-layer solid electrolyte separator is Li_{2.5-y}ZrCl_{5.5-y}O_{0.5} where 0<y≤1.0.

4. The solid-state battery cell of claim 1 wherein silicon particles in the silicon-based anode are selected from a group consisting of silicon nanoparticles, silicon microparticles, SiOₓ nanoparticles where 0<x<2, SiOₓ microparticles where 0<x<2, and silicon-carbon composites.

5. The solid-state battery cell of claim 1 wherein the nickel cobalt manganese in the cathode is LiNiₓCo_{y}Mn_{1-x-y}O₂, where x>0.7.

6. The solid-state battery cell of claim 5 wherein the nickel cobalt manganese is NCM811.

7. The solid-state battery cell of claim 1 wherein at least one of the anode and the cathode further includes a carbon additive.

8. The solid-state battery cell of claim 1 wherein at least one of the anode and the cathode further includes a polymeric binder.

9. The solid-state battery cell of claim 1 wherein at least one layer of the bi-layer solid electrolyte separator further includes a polymeric binder.

10. A method of manufacturing a solid-state battery cell comprising:
forming an anode by combining a silicon-active material with a sulfide-type solid electrolyte;
forming a cathode by combining a high-nickel nickel cobalt manganese with an oxychloride-type solid electrolyte;
forming a bi-layer solid electrolyte separator by depositing a first layer of sulfide-type solid electrolyte and depositing a second layer of oxychloride-type solid electrolyte on the first layer; and
assembling the anode, cathode, and bi-layer solid electrolyte separator such that the first layer of the separator is adjacent to the anode and the second layer of the separator is adjacent to the cathode.

11. The method of claim 10 wherein the sulfide-type solid electrolyte is an argyrodite having a formula Li₆PS₅X, where X is Cl or Br.

12. The method of claim 10 wherein the oxychloride-type solid electrolyte is Li_{2.5-y}ZrCl_{5.5-y}O_{0.5} where 0<y≤1.0.

13. The method of claim 10, further comprising adding a carbon additive to at least one of the anode and the cathode.

14. The method of claim 10, further comprising adding a polymeric binder to at least one of the anode, the cathode, and the bi-layer solid electrolyte separator.

15. A solid-state battery system comprising:
an anode composite of silicon active material and an argyrodite-type solid electrolyte;
a cathode composite of nickel cobalt manganese and a spinel-structured oxide solid electrolyte; and
a dual electrolyte solid separator between and in direct contact with the anode and the cathode, the separator having a first layer of argyrodite-type solid electrolyte adjacent to the anode and a second layer of spinel-structured oxide solid electrolyte adjacent to the cathode.

16. The solid-state battery system of claim 15 wherein the argyrodite-type solid electrolyte in the anode and the first layer of the separator is Li₆PS₅X, where X is Cl or Br, and the spinel-structured oxide solid electrolyte in the cathode and the second layer of the separator is Li_{2.5-y}ZrCl_{5.5-y}O_{0.5}.

17. The solid-state battery system of claim 15 wherein the silicon active material in the anode is selected from a group consisting of silicon nanoparticles, silicon microparticles, SiOx nanoparticles where 0<x<2, SiOₓ microparticles where 0<x<2, and silicon-carbon composites, and the nickel cobalt manganese in the cathode has the formula LiNiₓCo_{y}Mn_{1-x-y}O₂, where x>0.7.

18. The solid-state battery system of claim 17 wherein the nickel cobalt manganese is NCM811.

19. The solid-state battery system of claim 15 wherein at least one of the anode and the cathode includes a carbon additive.

20. The solid-state battery system of claim 15 wherein at least one layer of the dual electrolyte solid separator includes a polymeric binder.
